(19) United States
(12) Patent Application Publication
(10) Pub. No.: US 2014/0122858 A1
(43) Pub. Date: May 1, 2014

(54) METHOD FOR ACCELERATING BOOT-UP AND COMPUTER SYSTEM DEVICE

(71) Applicant: Acer Incorporated, New Taipei City (TW)

(72) Inventors: Han-Yi Tsai, New Taipei City (TW); Ching-Ho Tsai, New Taipei City (TW)

(73) Assignee: Acer Incorporated, New Taipei City (TW)

(21) Appl. No.: 13/901,574

(22) Filed: May 24, 2013

(30) Foreign Application Priority Data
Oct. 29, 2012 (TW) 101139968

(51) Int. Cl. G06F 9/44

(52) U.S. Cl. CPC G06F 9/4401
USPC 713/2

(57) ABSTRACT

A method for accelerating boot-up and a computer system device are provided. The method includes following steps. An adjusting procedure/program is executed, and the adjusting procedure/program includes adjusting at least one target procedure/program to be at least one delay-executing procedure/program according to a default list. After a boot-up process of the computer system device is completed, and after a default waiting period has passed, the at least one delay-executing procedure/program is executed. Since the service and/or application procedures/programs irrelevant to the boot-up process are not executed during the boot-up process, the boot-up of the computer system device is accelerated effectively.

### CROSS-REFERENCE TO RELATED APPLICATION

This application claims the priority benefit of Taiwan application serial no. 101139968, filed on Oct. 29, 2012. The entirety of the above-mentioned patent application is hereby incorporated by reference herein and made a part of this specification.

### BACKGROUND OF THE INVENTION

1. Field of the Invention

The invention relates to an electronic device. More particularly, the invention relates to a computer system device and a method for accelerating boot-up of the computer system device.

2. Description of Related Art

The face living pace in modern society leads to increasing concerns for the boot-up speed of a computer system device. Thus, the computer system devices capable of performing the fast-startup function have become more and more popular. In general, as the computer system device detects a shutdown event or a log-out event, the computer system device is able to record the current system state, the current memory state, and so forth. After the computer system device performs a boot-up process or a log-in process, the computer system device is able to retrieve the system state or the operation state of the computer system device according to the system state or the memory state recorded before the computer system device is shut down or logged out.

For instance, the Microsoft Windows 8 Operation System (OS) may, before the shutdown process is performed, record the current system state and the contents of memories in a system file named “HiberFile”. The OS is able to rapidly retrieve the previous system state or the previous operation state of the computer system device prior to the shutdown according to system file “HiberFile”, which is similar to the operation of switching from the hibernation mode (i.e., the S4 mode) back to the normal operation mode (i.e., the S0 mode), so as to rapidly complete the boot-up process.

However, the increasing number of service and/or application procedures/programs in the computer system device brings about the increasing number of service and/or application procedures/programs required by the computer system device for performing the boot-up process or for initialization, such that the boot-up speed of the computer system device is slowed down little by little. For instance, before running the shutdown process, the Windows 8 OS needs to record a great number of service and/or application procedures/programs in “HiberFile”; thus, the system file named “HiberFile” contains a lot of contents. During the boot-up process, the OS is required to spend a significant amount of time to read the bulky “HiberFile”. The more the number of service and/or application procedures/programs to be executed or initialized in the boot-up process, or the bulker the “HiberFile”, the slower the boot-up speed of the computer system device.

### SUMMARY OF THE INVENTION

Accordingly, the invention provides a boot-up accelerating method and a computer system device which may effectively speed up a boot-up process of the computer system device.

In an embodiment of the invention, a boot-up accelerating method suitable for accelerating boot-up speed of a computer system device includes following steps. An adjusting procedure/program is executed, and the adjusting procedure/program includes adjusting at least one target procedure/program to be at least one delay-executing procedure/program according to a default list. After a boot-up process is completed by the computer system device and after a default waiting period has passed, the at least one delay-executing procedure/program is executed.

In an embodiment of the invention, a computer system device that includes an adjusting module and an executing module is provided. The adjusting module is configured for executing an adjusting procedure/program; during the adjusting procedure/program, the adjusting module adjusts at least one target procedure/program to be at least one delay-executing procedure/program according to a default list. The executing module is connected to the adjusting module; after the computer system device completes a boot-up process and after a default waiting period has passed, the executing module executes the at least one delay-executing procedure/program.

In light of the above, according to the boot-up accelerating method and the computer system device provided in the embodiments of the invention, in the adjusting procedure/program, at least one target procedure/program may be adjusted to be at least one delay-executing procedure/program based on the default list. After the computer system device completes the boot-up process, and after the default waiting period has passed, the computer system device executes (or initializes) the delay-executing procedure/program. Thereby, the boot-up speed of the computer system device may be effectively accelerated.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a computer system device according to an embodiment of the invention.

FIG. 2 is a flowchart of a boot-up accelerating method according to an embodiment of the invention.

FIG. 3 is a flowchart of a boot-up accelerating method according to another embodiment of the invention.

FIG. 4 is a flowchart of generating/updating a default list according to an embodiment of the invention.

FIG. 5 is a flowchart of generating/updating a default list according to another embodiment of the invention.

### DESCRIPTION OF EMBODIMENTS

In an embodiment of the invention, a method for accelerating boot-up is provided, and thereby at least one target procedure/program (e.g., service and/or application procedures/programs) may be adjusted to be at least one delay-executing procedure/program. After the computer system device completes the boot-up process, and after a default waiting period has passed, the computer system device executes the at least one delay-executing procedure/program. Through the delay-executing procedure/program, the number of the service and/or application procedures/programs required for initialization in the boot-up process of the computer system device may be reduced, and thus the boot-up of the computer system device may be expedited. In addition, an embodiment of the invention further provides a computer system device to which the boot-up accelerating method may be applied. Several embodiments that exemplify that the invention can be carried out are provided below for explanatory purposes.

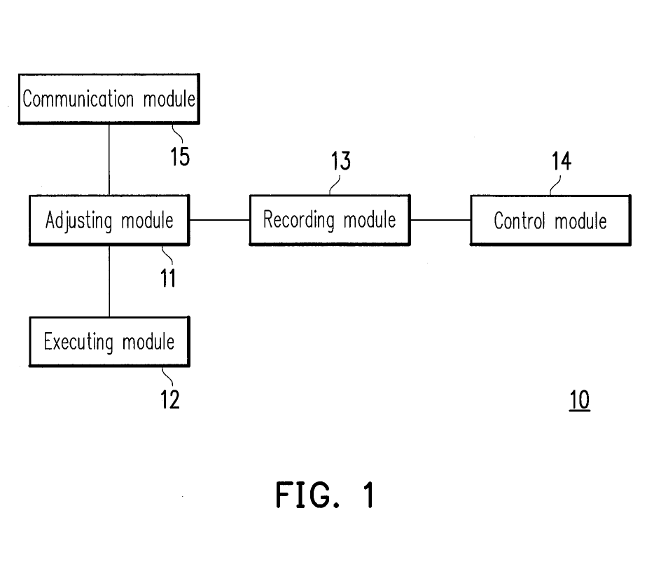

FIG. 1 is a block diagram illustrating a computer system device according to an embodiment of the invention. With reference to FIG. 1, the computer system device 10 includes an adjusting module 11 and an executing module 12 that is connected to the adjusting module 11. In the present embodiment, the computer system device 10 may load and run at least one operation system, such as a Microsoft Windows Operation System or any other operation system. Here, the computer system device 10 may be a cellular phone, a personal digital assistant (PDA), a smart phone, an electronic book, a game player, a notebook computer, a tablet PC, or any other portable electronic devices. Alternatively, the computer system device 10 may be a desktop computer device or a multimedia player operated on a computer system, which should not be construed as a limitation to the invention.

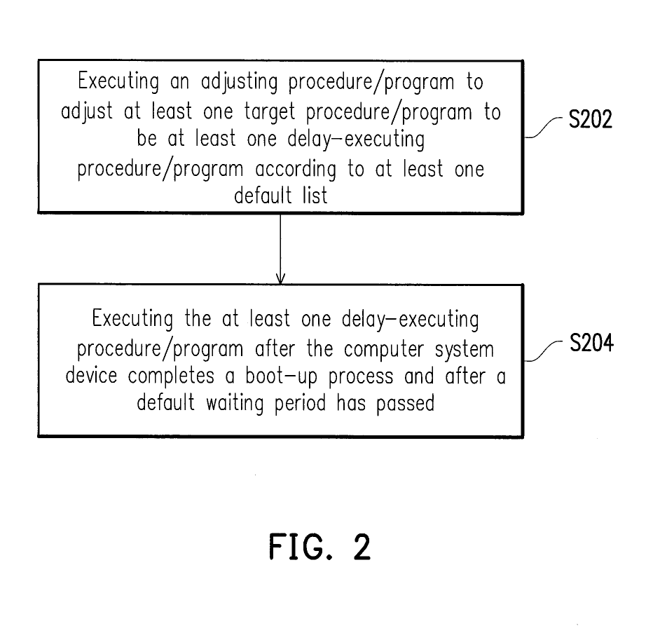

FIG. 2 is a flowchart of a boot-up accelerating method according to an embodiment of the invention. The computer system device 10 and the boot-up accelerating method provided herein will be described hereinafter with reference to FIG. 1 and FIG. 2. As shown in FIG. 1 and FIG. 2, in step S202, the adjusting module 11 executes an adjusting procedure/program. Particularly, in the adjusting procedure/program, the adjusting module 11 may adjust at least one target service procedure/program and/or at least one target application procedure/program (hereinafter collectively referred to as the target procedure/program) to be at least one delay-executing procedure/program according to at least one default list, so as to prevent the computer system device 10 from executing (or triggering/initializing) the delay-executing procedure/program during the boot-up process of the computer system device 10.

For instance, in the present embodiment, if the at least one target procedure/program refers to at least one service procedure/program, the adjusting module 11 can adjust an execution state of the at least one target procedure/program to be a manual execution state, configure the at least one target procedure/program as the at least one delay-executing procedure/program, and add the at least one delay-executing procedure/program to a task scheduler of the computer system device 10. Since the execution state of the at least one target procedure/program (the target service procedure/program) is configured to be the manual execution state, the operation system does not execute (nor trigger/initialize) the target service procedure/program in the boot-up process of the computer system device 10. Besides, the at least one target procedure/program (the target service procedure/program) is added to the task scheduler; therefore, after the boot-up process is completed, and after a default waiting period has passed, the operation system executes the target service procedure/program according to the task scheduler.

Alternatively, if the at least one target procedure/program refers to at least one application procedure/program, the adjusting module 11 can remove registration information of the at least one target procedure/program from a registry of the operation system of the computer system device 10, configure the at least one target procedure/program as the at least one delay-executing procedure/program, and add the at least one delay-executing procedure/program to a task scheduler of the computer system device 10. Since the registration information of the at least one target procedure/program (the target application procedure/program) in the registry is removed first, the operation system does not spontaneously execute (nor trigger/initialize) the target application procedure/program in the boot-up process of the computer system device 10. Besides, the at least one target procedure/program (the target application procedure/program) is added to the task scheduler; therefore, after the boot-up process is completed, and after a default waiting period has passed, the operation system executes the target application procedure/program according to the task scheduler.

In the present embodiment, the default list is exemplarily stored in a storage medium of the computer system device 10 in advance or obtained from other sources, which will be elaborated hereinafter. In addition, the at least one target procedure/program (the target service and/or application procedures/programs) in the default list must be a procedure/program that is not required by the computer system device 10 for completing the boot-up process. That is, if certain service or application procedure/program is required by the computer system device 10 for completing the boot-up process, the adjusting module 11 does not select such service or application procedure/program as a target procedure/program nor adjusts such service or application procedure/program to be the delay-executing procedure/program, so as to prevent the computer system device 10 from not being able to complete the boot-up process. For instance, the adjusting module 11 may look up a table and filter out the service or application procedure/program required by the computer system device 10 for completing the boot-up process, such that the adjusting module 11 does not configure the required service or application procedure/program as the delay-executing procedure/program in the adjusting procedure/program by mistake. The registry of the operation system may, for instance, have an attributes column that indicates whether a certain application procedure/program is required for completing the boot-up process. The adjusting module 11 can thus in step S202 determine whether the target procedure/program in the default list is required for completing the boot-up process according to the contents of the registry of the operation system and correspondingly adjust the contents of the default list, such that the adjusting module 11 does not configure the required service or application procedure/program as the delay-executing procedure/program in the adjusting procedure/program by mistake.

In step S204, after the computer system device 10 completes the boot-up process and after a default waiting period has passed, the executing module 12 executes the at least one delay-executing procedure/program. It should be mentioned that the default waiting period serves to prevent premature execution of the delay-executing procedure/program, while the duration of the default waiting period may be adjusted according to actual demands and should not be construed as a limitation to the invention.

For instance, when the computer system device 10 detects a boot-up event and correspondingly executes the boot-up process, the executing module 12 triggers the task scheduler. Here, the delay-executing procedure/program configured in step S202 is assumed to be recorded by the task scheduler, and the task scheduler also records the execution of the delay-executing procedure/program after the boot-up process is completed and after the default waiting period (e.g., 1 minute, 3 minutes, or the like) has passed. Hence, after the computer system device 10 completes the boot-up process, and after 1 minute (or 3 minutes or so) has passed, the executing module 12 executes the delay-executing procedure/program according to the task scheduler of the operation system.

In another embodiment, given that the computer system device 10 is unable to exactly know whether the boot-up process is completed or not, it is also likely for the executing module 12 to determine whether to execute the delay-executing procedure/program merely according to the default waiting period. For instance, when the computer system device 10 detects a boot-up event and correspondingly executes the boot-up process, the executing module 12 triggers the task scheduler. After five minutes from the boot-up event, the executing module 12 executes the delay-executing procedure/program according to the record of the task scheduler. Note that the executing module 12 executes the delay-executing procedure/program by initializing the delay-executing procedure/program or setting configurations of the delay-executing procedure/program, for instance, which will be determined according to the operational manner of the service or application procedure/program.

In the present embodiment, the time at which the adjusting module 11 executes the adjusting procedure/program is determined by the time at which a service-adjusting procedure/program of the adjusting module 11 is installed in the computer system device 10. For instance, if the adjusting procedure/program corresponding to the adjusting module 11 is installed in the computer system device 10, the adjusting module 11 executes the adjusting procedure/process. The adjusting module 11 may also execute the adjusting procedure/program at another time. For instance, when the computer system device 10 updates the default list, the adjusting module 11 may execute the adjusting procedure/program according to the updated default list, which should not be construed as a limitation to the invention.

In other words, according to the default list, at least one target procedure/program may be configured as the delay-executing procedure/program, and the delay-executing procedure/program is not executed in the boot-up process, so as to expedite the boot-up of the computer system device 10. After the boot-up process is completed and after the default waiting period has passed, the at least one delay-executing procedure/program is one by one executed/triggered/initialized according to the setup of the task scheduler.

In view of the development of the existing computer systems, certain computer systems may spontaneously record the attributes and states of some of the running service or application procedures/programs before these computer systems are shut down. At the next boot-up time, the computer system device is able to rapidly initialize the service or application procedures/programs according to the previously recorded attributes or states of these service or application procedures/programs, so as to retrieve the system state of the computer system device prior to the shutdown. For instance, the Microsoft Windows 8 OS may, before the shutdown process is performed, record the current system state and the contents of memories in “HiberFile” system file. The OS is able to rapidly retrieve the previous system state or the previous operation state of the computer system device prior to the shutdown according to the contents of a system file named “HiberFile”, which is similar to the operation of switching from the hibernation mode (i.e., the S4 mode) back to the normal operation mode (i.e., the S0 mode), so as to rapidly complete the boot-up process. However, the increasing number of service and/or application procedures/programs in the computer system device brings about the increasing number of service and/or application procedures/programs required by the computer system device for performing the boot-up process or for initialization. That is, before running the shutdown process, the Windows 8 OS needs to record a great number of service and/or application procedures/programs in the “HiberFile”, thus, the “HiberFile” contains a lot of contents. During the boot-up process, the OS is required to spend a significant amount of time to read the bulky “HiberFile”.

The more the number of service and/or application procedures/programs to be executed or initialized in the boot-up process, or the bulker the “HiberFile”, the slower the boot-up speed of the computer system device 10. Hence, in an embodiment of the invention, when the computer system device 10 starts to perform a shutdown process, the computer system device 10 may set a state of the at least one delay-executing procedure/program as an off or a disabled state. Hence, before the Windows 8 OS runs the shutdown process, the at least one target procedure/program (the at least one service and/or application procedure/program) is not recorded in the “HiberFile”; thus, the file size of the “HiberFile” is significantly reduced. At the next boot-up time, the reduced file size of the “HiberFile” allows the OS to read the “HiberFile” within a relatively short period of time, thereby expediting the boot-up of the computer system device 10.

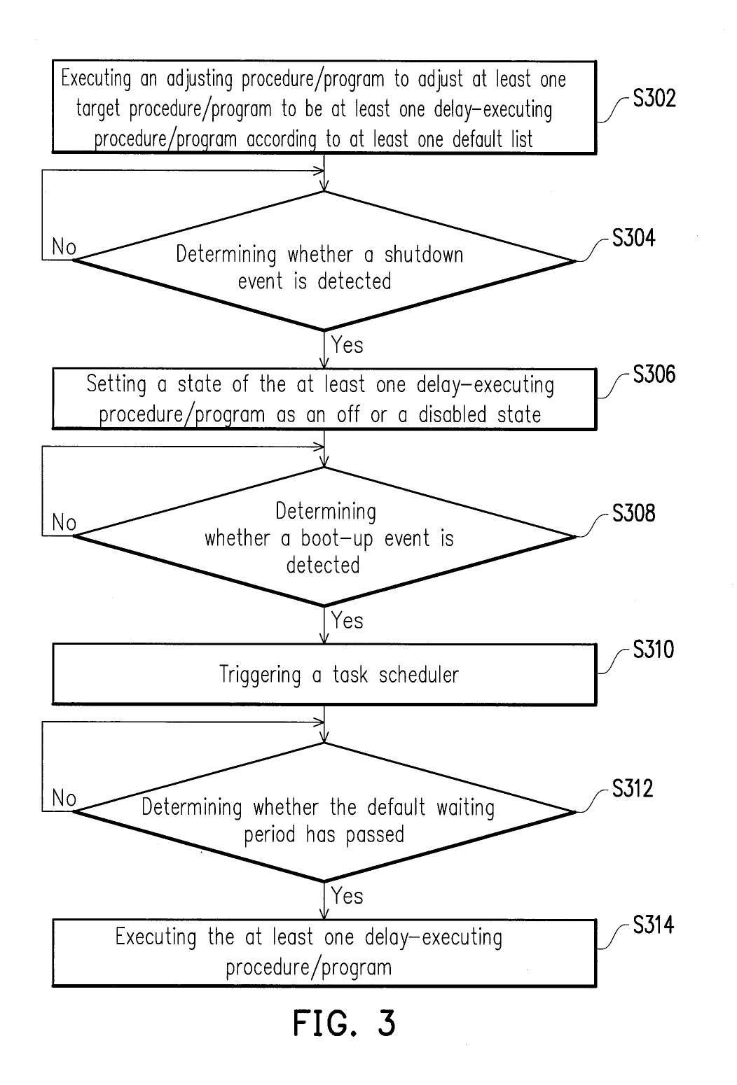

FIG. 3 is a flowchart of a boot-up accelerating method according to another embodiment of the invention. The boot-up accelerating method in the present embodiment is explained hereinafter with reference to FIG. 1 and FIG. 3. As shown in FIG. 1 and FIG. 3, in step S302, the adjusting module 11 executes the adjusting procedure/program, so as to adjust at least one target procedure/program to be at least one delay-executing procedure/program according to at least one default list. The description of the detailed adjusting procedure/program may be referred to as the description of step S202 in the previous embodiment and thus will not be further provided hereinafter.

In step S304, the adjusting module 11 determines whether a shutdown event is detected. Note that the shutdown event herein refers to an event (issued by the computer system) of switching a user session to a kernel session or a user session log-off event, for instance, and thereby the adjusting module 11 may determine whether the computer system device 10 is about to perform the shutdown process. If the adjusting module 11 does not detect any shutdown event, the adjusting module 11 repeatedly performs the step S304. By contrast, if the adjusting module 11 detects the shutdown event, the adjusting module 11 performs step S306 subsequently. In step S306, the adjusting module 11 sets a state of the at least one delay-executing procedure/program as an off or a disabled state (or a non-operating/non-active state), so as to prevent the computer system device 10 from writing the delay-executing procedure/program into any system file relevant to the boot-up process during the shutdown process. For instance, in the Windows 8 OS, the system file relevant to the boot-up process may refer to the “HiberFile” or any other system file which has similar functions in other computer systems.

After the step S306 is completed, the computer system device 10 continues to perform the shutdown process. For instance, during the shutdown process, the exemplary Windows 8 OS writes all the service procedures/programs in an on state (or in an enabled state) into the “HiberFile” and writes all the application procedures/programs in an on state (or in an enabled state) into the “HiberFile” according to the registration information of the registry of the OS. After the shutdown process is completed, the computer system device 10 enters the off state.

In the following step S308, the executing module 12 determines whether a boot-up event (e.g., a boot-up signal generated by a user pressing a boot-up button) is detected. If the executing module 12 does not detect any boot-up event in step S308, the executing module 12 repeatedly performs the step S308. By contrast, if the executing module 12 detects the boot-up event, the executing module 12 triggers the task scheduler in step S310, so as to execute the delay-executing procedure/program after the default waiting period (e.g., 1 minute, 3 minutes, or any other period) has passed. On the other hand, the computer system device 10 performs the boot-up process. For instance, the Windows 8 OS is able to rapidly retrieve the previous system state or the previous operation state of the computer system device prior to the shutdown according to the contents of the “HiberFile” system file, so as to rapidly complete the boot-up process.

In step S312, the executing module 12 determines whether the default waiting period has passed according to the setup of the task scheduler. If the executing module 12 determines that the default waiting period has not passed yet in step S312, the executing module 12 repeatedly performs the step S312. If the default waiting period has passed, the executing module 12 performs step S314. In step S314, the executing module 12 starts to execute the delay-executing procedure/program according to the task scheduler.

With reference to FIG. 1, in order to adaptively generate/update the default list, the computer system device 10 in another embodiment of the invention may also include a recording module 13 and a control module 14. The recording module 13 is connected to the adjusting module 11 and the control module 14, and configured for recording at least one service procedure/program and/or at least one application procedure/program in the boot-up process performed by the computer system device 10 and recording a time frame of initializing the at least one service procedure/program and/or the at least one application procedure/program in the boot-up process, respectively. In the present embodiment, the memory module 13 includes at least one storage medium (e.g., a memory or a hard drive).

The control module 14 is connected to the recording module 13 and configured for generating/updating the default list according to the time frame of initializing the at least one service procedure/program and/or the at least one application procedure/program in the boot-up process. Thereby, in the boot-up process of the computer system device 10, the computer system device 10 merely initializes some of the service and/or application procedures/programs, while the other service and/or application procedures/programs are configured as the delay-executing procedures/programs, so as to postpone the time of initialization. For instance, in an embodiment of the invention, the computer system device 10 during the boot-up process merely initializes the service and/or application procedures/programs that are less time-consuming, while the service and/or application procedures/programs that are rather time-consuming are configured as the delay-executing procedures/programs. These delay-executing procedures/programs are initialized after the boot-up process is completed. In another embodiment of the invention, the computer system device 10 during the boot-up process merely initializes the service and/or application procedures/programs that are often used or of great importance, while the service and/or application procedures/programs that are less used or of less importance are configured as the delay-executing procedures/programs. These delay-executing procedures/programs are initialized after the boot-up process is completed.

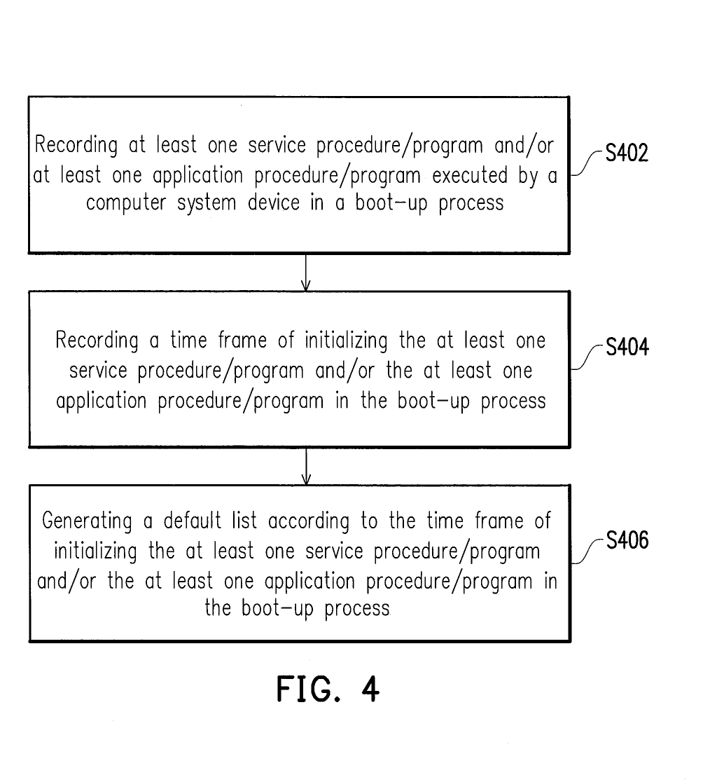

FIG. 4 is a flowchart of generating/updating a default list according to an embodiment of the invention. How the recording module 13 and the control module 14 generate/update the default list will be elaborated hereinafter with reference to FIG. 1 and FIG. 4. As shown in FIG. 1 and FIG. 4, in step S402, the recording module 13 records at least one service procedure/program and/or at least one application procedure/program executed by the computer system device 10 in at least one boot-up process. Particularly, the at least one service procedure/program and/or the at least one application procedure/program recorded by the recording module 13 is not required by the computer system device 10 for completing the boot-up process. In step S404, the recording module 13 records a time frame of initializing the at least one service procedure/program and/or the at least one application procedure/program in the boot-up process, respectively. For instance, as long as the computer system process 10 undergoes the boot-up process, the recording module 13 records and updates the time frame of initializing each service procedure/program and/or service application procedure/program in an information table, and the control module 14 may obtain the information by looking up the information table.

In step S406, the control module 14 generates/updates the default list according to the time frame of initializing the at least one service procedure/program and/or the at least one application procedure/program in the boot-up process. For instance, the control module 14 compares the respective time frame of initializing the at least one service procedure/program and/or the at least one application procedure/program in the boot-up process with a threshold value; if the time frame of initializing the at least one service procedure/program and/or the at least one application procedure/program in the boot-up process is longer than the threshold value, the control module 14 configures the at least one service procedure/program and/or the at least one application procedure/program as the at least one target procedure/program. The control module 14 then fills out the default list with the at least one target procedure/program, so as to generate/update the default list.

In another embodiment, the recording module 13 may also add at least one column to the registry, and stores the time frame of initializing the at least one service procedure/program and/or the at least one application procedure/program in the boot-up process in form of parameters or codes into the at least one column of the registry. According to the stored parameters or the stored codes in the registry corresponding to each service procedure/program and/or each application procedure/program, the control module 14 is able to select the target procedure/program. The control module 14 then fills out the default list with the at least one target procedure/program, so as to generate/update the default list.

However, the way to generate/update the default list as explained in the present embodiment should not be limited to that described herein. For instance, in another embodiment of the invention, the recording module 13 may also record the number of times or a time frame of executing the at least one service procedure/program and/or the at least one application procedure/program within an evaluation period, respectively. The control module 14 may then generate/update the default list according to the number of times or the time frame of executing the at least one service procedure/program and/or the at least one application procedure/program within the evaluation period. As a result, the computer system device may adaptively generate/update the default list based on the number of times or the time frame of executing the at least one service procedure/program and/or the at least one application procedure/program within the evaluation period, so as to accelerate the boot-up process without sacrificing the user's convenience of use.

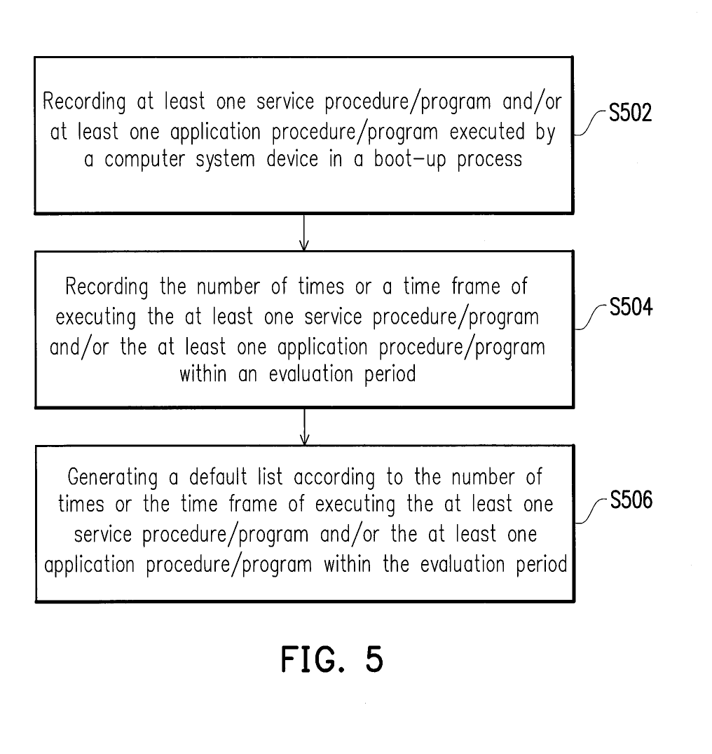

FIG. 5 is a flowchart of generating/updating a default list according to another embodiment of the invention. With reference to FIG. 1 and FIG. 5, in step S502, the recording module 13 records at least one service procedure/program and/or at least one application procedure/program executed by the computer system device 10 in a boot-up process. Particularly, the at least one service procedure/program and/or the at least one application procedure/program recorded by the recording module 13 is not required by the computer system device 10 for completing the boot-up process. In step S504, the recording module 13 records the number of times or a time frame of executing the at least one service procedure/program and/or the at least one application procedure/program within an evaluation period. For instance, the recording module 13 may record and update the number of times or the time frame of executing each service procedure/program and/or each application procedure/program within a day or a week in an information table. The evaluation period may be adjusted according to actual requirements and should not be construed as a limitation to the invention.

In step S506, the control module 14 may generate/update the default list according to the number of times or the time frame of executing the at least one service procedure/program and/or the at least one application procedure/program within the evaluation period. For instance, the control module 14 may compare the number of times of executing the at least one service procedure/program and/or the at least one application procedure/program within the evaluation period with a threshold number of times; if the number of times of executing the at least one service procedure/program and/or the at least one application procedure/program within the evaluation period is less than the threshold number of times, the control module 14 configures the at least one service procedure/program and/or the at least one application procedure/program as the at least one target procedure/program. The control module 14 then fills out the default list with the at least one target procedure/program, so as to generate/update the default list.

Alternatively, the control module 14 may in step S506 compare the time frame of executing the at least one service procedure/program and/or the at least one application procedure/program within the evaluation period with a threshold time frame; if the time frame of executing the at least one service procedure/program and/or the at least one application procedure/program within the evaluation period is shorter than the threshold time frame, the control module 14 configures the at least one service procedure/program and/or the at least one application procedure/program as the at least one target procedure/program. The control module 14 then fills out the default list with the at least one target procedure/program, so as to generate/update the default list.

In another embodiment, the recording module 13 may also add at least one column to the registry and stores the number of times and/or the time frame of executing each service procedure/program and/or each application procedure/program within the evaluation time (e.g., one day or one week) in form of parameters or codes into the at least one column to the registry. According to the stored parameters or the stored codes in the registry corresponding to each service procedure/program and/or each application procedure/program, the control module 14 is able to select the target procedure/program. The control module 14 then fills out the default list with the at least one target procedure/program, so as to generate/update the default list.

Note that the recording module 13 described in the previous embodiments may determine the service or application procedures/programs not required by the computer system device 10 for initialization in the boot-up process and record the service or application procedures/programs required by the computer system device 10 for completing the boot-up process. The control module 14 then selects the target procedures/programs from the service or application procedures/programs not required for completing the boot-up process as the delay-executing procedures/programs and fills out the default list with these delay-executing procedures/programs. In another embodiment, the recording module 13 may record all of the service or application procedures/programs required by the computer system device 10 for initialization in the boot-up process. From the record of the recording module 13, the control module 14 first selects the target procedures/programs that may serve as the delay-executing procedures/programs and then filters out the service or application procedures/programs required by the computer system device 10 for completing the boot-up process. After that, the control module 13 fills out the default list with the target procedures/programs that are not required by the computer system device 10 for completing the boot-up process.

In another embodiment of the invention, the computer system device 10 may further include a communication module 15. The communication module 15 is connected to the adjusting module 11 and configured for obtaining the default list from a remote host through wire/wireless network. For instance, the communication module 15 may be periodically connected to the remote host to download and update the default list from the remote host. Here, the communication module 15 may include a network interface card, a wireless network interface card, a radio frequency circuit, and so forth, which should not be construed as a limitation to the invention.

Note that the adjusting module, the executing module, the recording module, the control module, and the communication module may be hardware apparatuses constituted by logic circuit devices which may respectively perform the corresponding functions. In other embodiments, these modules may also be software modules or firmware programs stored in the hard disk or the memory of the computer system device, and these modules may be loaded to the processor of the computer system device for respectively performing the corresponding functions.

To sum up, in the boot-up accelerating method and the computer system device provided in the embodiments of the invention, at least one target procedure/program may be adjusted to be at least one delay-executing procedure/program according to the default list. During the boot-up process executed by the computer system device, the delay-executing procedure/program is not executed. After the computer system device completes the boot-up process, and after the default waiting period has passed, the computer system device executes the delay-executing procedure/program. Through the delay-executing procedure/program, the number of the service and/or application procedures/programs required for initialization in the boot-up process of the computer system device may be reduced, and thus the boot-up of the computer system device may be expedited. In addition, as described in the embodiments of the invention, the default list may be adaptively generated/updated; alternatively, the default list may also be downloaded and updated from the remote host.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A boot-up accelerating method suitable for accelerating boot-up speed of a computer system device, the boot-up accelerating method comprising:
executing an adjusting procedure/program comprising: adjusting at least one target procedure/program to be at least one delay-executing procedure/program according to a default list; and
executing the at least one delay-executing procedure/program after a boot-up process is completed by the computer system device and after a default waiting period has passed.

2. The boot-up accelerating method as recited in claim 1, further comprising:
executing the adjusting procedure/program when a service-adjusting procedure/program is installed in the computer system device,
wherein the at least one target procedure/program comprises at least one target service procedure/program and/or at least one target application procedure/program.

3. The boot-up accelerating method as recited in claim 1, further comprising:
recording at least one service procedure/program and/or at least one application procedure/program in the boot-up process performed by the computer system device, wherein the at least one service procedure/program and/or the at least one application procedure/program is not required by the computer system device for completing the boot-up process;
recording a time frame of initializing the at least one service procedure/program and/or the at least one application procedure/program in the boot-up process, respectively; and
generating the default list according to the time frame of initializing the at least one service procedure/program and/or the at least one application procedure/program in the boot-up process.

4. The boot-up accelerating method as recited in claim 3, wherein the step of generating the default list comprises:
comparing the respective time frame of initializing the at least one service procedure/program and/or the at least one application procedure/program in the boot-up process with a threshold value, and configuring the at least one service procedure/program and/or the at least one application procedure/program as the at least one target procedure/program if the time frame of initializing the at least one service procedure/program and/or the at least one application procedure/program in the boot-up process is longer than the threshold value; and
filling out the default list with the at least one target procedure/program.

5. The boot-up accelerating method as recited in claim 1, further comprising:
recording at least one service procedure/program and/or at least one application procedure/program in the boot-up process performed by the computer system device, wherein the at least one service procedure/program and/or the at least one application procedure/program is not required by the computer system device for completing the boot-up process;
respectively recording the number of times or a time frame of executing the at least one service procedure/program and/or the at least one application procedure/program within an evaluation period; and
generating the default list according to the number of times or the time frame of executing the at least one service procedure/program and/or the at least one application procedure/program within the evaluation period.

6. The boot-up accelerating method as recited in claim 5, wherein the step of generating the default list comprises:
comparing the number of times of executing the at least one service procedure/program and/or the at least one application procedure/program within the evaluation period with a threshold number of times, and configuring the at least one service procedure/program and/or the at least one application procedure/program as the at least one target procedure/program if the number of times of executing the at least one service procedure/program and/or the at least one application procedure/program within the evaluation period is less than the threshold number of times; and
filling out the default list with the at least one target procedure/program.

7. The boot-up accelerating method as recited in claim 5, wherein the step of generating the default list comprises:
comparing the time frame of executing the at least one service procedure/program and/or the at least one application procedure/program within the evaluation period with a threshold time frame, and configuring the at least one service procedure/program and/or the at least one application procedure/program as the at least one target procedure/program if the time frame of executing the at least one service procedure/program and/or the at least one application procedure/program within the evaluation period is shorter than the threshold time frame; and
filling out the default list with the at least one target procedure/program.

8. The boot-up accelerating method as recited in claim 1, further comprising:
setting a state of the at least one delay-executing procedure/program as an off or a disabled state when the computer system device starts to perform a shutdown process.

9. The boot-up accelerating method as recited in claim 1, wherein the step of adjusting the at least one target procedure/program to be the at least one delay-executing procedure/program comprises:
adjusting an execution state of the at least one target procedure/program to be a manual execution state; and
configuring the at least one target procedure/program as the at least one delay-executing procedure/program and adding the at least one delay-executing procedure/program to a task scheduler of the computer system device.

10. The boot-up accelerating method as recited in claim 1, wherein the step of adjusting the at least one target procedure/program to be the at least one delay-executing procedure/program comprises:
removing registration information of the at least one target procedure/program from a registry of the computer system device; and
configuring the at least one target procedure/program as the at least one delay-executing procedure/program and adding the at least one delay-executing procedure/program to a task scheduler of the computer system device.

11. A computer system device comprising:
an adjusting module configured for executing an adjusting procedure/program, during the adjusting procedure/program, the adjusting module adjusting at least one target procedure/program to be at least one delay-executing procedure/program according to a default list; and
an executing module connected to the adjusting module, wherein the executing module executes the at least one delay-executing procedure/program after the computer system device completes a boot-up process and after a default waiting period has passed.

12. The computer system device as recited in claim 11, wherein the at least one target procedure/program comprises at least one target service procedure/program and/or at least one target application procedure/program, and
the adjusting module executes the adjusting procedure/program when a service-adjusting procedure/program is installed in the computer system device.

13. The computer system device as recited in claim 11, further comprising:
a recording module connected to the adjusting module, and configured for recording at least one service procedure/program and/or at least one application procedure/program in the boot-up process performed by the computer system device and recording a time frame of initializing the at least one service procedure/program and/or the at least one application procedure/program in the boot-up process, respectively, wherein the at least one service procedure/program and/or the at least one application procedure/program is not required by the computer system device for completing the boot-up process; and
a control module connected to the recording module and configured for generating the default list according to the time frame of initializing the at least one service procedure/program and/or the at least one application procedure/program in the boot-up process,
wherein the control module compares the respective time frame of initializing the at least one service procedure/program and/or the at least one application procedure/program in the boot-up process with a threshold value, and if the time frame of initializing the at least one service procedure/program and/or the at least one application procedure/program in the boot-up process is longer than the threshold value, the control module configures the at least one service procedure/program and/or the at least one application procedure/program as the at least one target procedure/program and fills out the default list with the at least one target procedure/program.

14. The computer system device as recited in claim 11, further comprising:
a recording module connected to the adjusting module, and configured for recording at least one service procedure/program and/or at least one application procedure/program in the boot-up process performed by the computer system device and respectively recording the number of times or a time frame of executing the at least one service procedure/program and/or the at least one application procedure/program within an evaluation period, wherein the at least one service procedure/program and/or the at least one application procedure/program is not required by the computer system device for completing the boot-up process; and
a control module connected to the recording module, and configured for generating the default list according to the number of times or the time frame of executing the at least one service procedure/program and/or the at least one application procedure/program within the evaluation period.

15. The computer system device as recited in claim 14, wherein the control module compares the number of times of executing the at least one service procedure/program and/or the at least one application procedure/program within the evaluation period with a threshold number of times, configures the at least one service procedure/program and/or the at least one application procedure/program as the at least one target procedure/program if the number of times of executing the at least one service procedure/program and/or the at least one application procedure/program within the evaluation period is less than the threshold number of times, and fills out the default list with the at least one target procedure/program.

16. The computer system device as recited in claim 14, wherein the control module compares the time frame of executing the at least one service procedure/program and/or the at least one application procedure/program within the evaluation period with a threshold time frame, configures the at least one service procedure/program and/or the at least one application procedure/program as the at least one target procedure/program if the time frame of executing the at least one service procedure/program and/or the at least one application procedure/program within the evaluation period is shorter than the threshold time frame, and fills out the default list with the at least one target procedure/program.

17. The computer system device as recited in claim 11, further comprising:
a communication module connected to the adjusting module and configured for obtaining the default list from a remote host through wire/wireless network.

18. The computer system device as recited in claim 11, wherein the adjusting module further sets a state of the at least one delay-executing procedure/program as an off or a disabled state when the computer system device starts to perform a shutdown process.

19. The computer system device as recited in claim 11, wherein the adjusting module adjusts an execution state of the at least one target procedure/program to be a manual execution state, configures the at least one target procedure/program as the at least one delay-executing procedure/program, and adds the at least one delay-executing procedure/program into a task scheduler of the computer system device.

20. The computer system device as recited in claim 11, wherein the adjusting module removes registration information of the at least one target procedure/program from a registry of the computer system device, configures the at least one target procedure/program as the at least one delay-executing procedure/program, and adds the at least one delay-executing procedure/program into a task scheduler of the computer system device.
